(19) United States
(12) Patent Application Publication
(10) Pub. No.: US 2003/0133854 A1
(43) Pub. Date: Jul. 17, 2003

(54) System for supplying a gas and method of supplying a gas

(75) Inventors: Yoichiro Tabata, Tokyo (JP); Akaru Usui, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/210,872

(22) Filed: Aug. 2, 2002

(30) Foreign Application Priority Data
Jan. 17, 2002 (JP) 2002-008685

(51) Int. Cl. B01J 19/08

(52) U.S. Cl. 422/186.07; 422/186.12; 422/186.14

(57) ABSTRACT

The present invention provides a system for supplying a gas capable of supplying a gas at a proper flow rate and forming a gas at a proper rate from a gas-forming unit. The invention provides a system for supplying a gas including a gas-forming unit, a gas supply passage for supplying a gas produced from the gas-forming unit, a gas flow rate controller provided in the gas supply passage, a gas discharge passage provided in parallel with the gas supply passage to discharge the gas produced from the gas-forming unit, and a pressure controller provided in the gas discharge passage to control the pressure of the gas flowing through the gas discharge passage. In the above system for supplying a gas, it is possible to optimize the flow rate of the gas that is supplied and the amount of the gas generated by the gas-forming unit.

### BACKGROUND OF THE INVENTION

1. Field of the Invention

This invention relates to a system for supplying a gas such as ozone gas, formed gas, reaction gas or the like gas to a treating apparatus and to a method of supplying a gas.

2. Description of the Related Art

A system for supplying a gas, in general, is constituted by a gas-forming unit for forming a gas such as ozone gas, formed gas, reaction gas or the like gas, a conduit connected to the gas-forming unit and to a treating apparatus to introduce the gas produced from the gas-forming unit to the treating apparatus, and a gas flow rate control unit provided in the conduit to adjust the flow rate of the gas supplied to the treating apparatus from the gas-forming unit.

Such a system for supplying a gas has been utilized in a variety of fields where a gas is supplied to a treating apparatus inclusive of the process of manufacturing semiconductor devices in which, for example, an ozone gas or a reaction gas formed in the gas-forming unit is supplied to a semiconductor treating apparatus which accommodates semiconductor wafers therein, and the treatment for the semiconductor wafers (film-forming treatment, wafer-washing treatment, resist-peeling treatment, etching treatment, etc.) is conducted with the ozone gas or the reaction gas in the semiconductor-treating apparatus.

FIG. 17 is a diagram illustrating the above conventional system for supplying a gas disclosed in Japanese Patent Laid-Open Hei 8-133707. If described in detail, this diagram illustrates a system for supplying an ozone gas to a CVD (chemical vapor deposition) film-forming apparatus for forming a silicon oxide film on a semiconductor wafer.

As shown in the figure, an oxygen gas which is a starting gas is supplied to an ozone-generating apparatus 3 through a conduit 1, and a nitrogen gas which is another starting gas is supplied to the ozone-generating apparatus 3 through a conduit 2. Here, the flow rate of the oxygen gas flowing through the conduit 1 is controlled by a gas on/off valve 11, a gas reducing valve 12 and a mass flow rate controller (MFC) 13 provided in the conduit 1, and the flow rate of the nitrogen gas flowing through the conduit 2 is controlled by a gas on/off valve 21, a gas reducing valve 22 and a mass flow rate controller (MFC) 23 provided in the conduit 2.

The starting gases are supplied into the ozone-generating apparatus 3, i.e., are supplied to an ozone generator (cell) 31 provided in the ozone-generating apparatus 3 and having opposing electrodes to work as a gas generator. Here, the starting gases are supplied being so controlled that nitrogen is contained in oxygen that has a pressure of not lower than 1 atm. At the same time, a high voltage is applied across the electrodes of the ozone generator 31 by a high-frequency high-voltage power source (ozonizer power source) 32 to generate a silent discharge across the electrodes, so that an ozone gas is formed by the ozone generator 31. Informing ozone, heat discharge is generated accompanying the voiceless discharge. Therefore, the electrode cells are cooled with water from a cooling device 33 to cool the heat discharge.

The thus formed ozone gas is produced from a gas output pipe 35 in which a gas filter 34 is provided, and is supplied to a semiconductor treating apparatus (chamber for treatment) 5 through a gas supply pipe 4 connected to a gas output pipe 35. The gas supply pipe 4 is provided with a mass flow rate controller (MFC) 41 which controls the flow rate of the ozone gas that flows through the gas supply pipe 4.

A conduit 6 communicated with the semiconductor treating apparatus 5 is branched from the conduit 2, and the nitrogen gas is supplied to a tetraethyl orthosilicate (hereinafter referred to as TEOS) supply unit 62 through a mass flow rate controller (MFC) 61 provided in the conduit 6. The liquid TEOS is vaporized in the TEOS supply unit 62 by the nitrogen gas, and the TEOS gas is supplied to the chamber 5.

In the chamber 5, a silicon oxide film is formed on the semiconductor wafer due to the chemical reaction of the ozone gas supplied through the conduit 4 with the TEOS gas supplied through the conduit 6. The gas remaining in the chamber 5 is discharged through a check valve 71 and a gas-decomposing apparatus (waste ozone-treating apparatus) 72 provided in a conduit 7.

In the conventional system for supplying a gas and in the conventional method of supplying a gas, the gas formed by the gas-forming unit 31 is supplied to the treating apparatus 5 through the gas supply pipe 4 that connects the gas-forming unit 31 to the treating apparatus 5. Therefore, if the flow rate of the gas supplied to the treating apparatus 5 is controlled to a proper value, the pressure is affected in the gas-forming unit 31 that is connected to the gas supply pipe 4 on the side opposite to the treating apparatus 5.

The amount of gas formed by the gas-forming unit 31 affects the pressure in the gas-forming unit 31. Therefore, if the pressure in the gas-forming unit 31 is affected as a result of controlling the flow rate of the gas supplied into the treating apparatus 5, the amount of gas formed in the gas-forming unit 31 is also affected, making it difficult to properly control the amount of the gas that is formed in the gas-forming unit 31.

In the case of the system for supplying a gas used for the above process of manufacturing the semiconductor devices, in particular, it is necessary to maintain the pressure constant within a range of from 1 to several hundred Torr in the semiconductor-treating apparatus 5 and to control, in real time, the amounts of the TEOS gas and of the ozone gas that are supplied, in order to control the amount of deposition of the silicon oxide film and to improve the quality of the oxide film. Further, the pressure in the ozone generator 31 must be so controlled as will be not lower than 1 atm by taking the amount of ozone gas formation into consideration. If precedence is given to controlling the amount of the gas supplied to the semiconductor-treating apparatus 5, a proper pressure is not maintained in the ozone generator 31, and performance for generating ozone decreases.

Here, it can be contrived to provide a valve in the gas output portion to suppress the effect upon the pressure in the gas-forming unit. However, a simple provision of the valves is not enough for controlling the flow rate of the gas by opening and closing the valve, and is not enough, either, to impart a predetermined pressure loss relying upon the gas flow rate by adjusting the operation valve.

According to the conventional system for supplying a gas and the conventional method of supplying a gas, further, the pressure in the gas-forming unit is affected as a result of controlling the flow rate of the gas supplied to the treating apparatus that is connected. Therefore, the effect upon the pressure increases with an increase in the number of the treating apparatuses that are connected. In order to decrease the effect upon the pressure in the gas-forming unit, therefore, it is necessary to decrease the number of the treating apparatuses connected to one gas-forming unit. As a result, there is caused a problem that it is not allowed to connect a plurality of treating apparatuses to the one gas-forming unit.

### SUMMARY OF THE INVENTION

An object of the invention is to provide a system for supplying a gas and a method of supplying a gas which make it possible to supply a gas at a proper flow rate and to form a gas at a proper rate in a gas-forming unit.

An another object of the present invention is to provide a system for supplying a gas and a method of supplying a gas which make it possible to supply a gas stably to a plurality of treating apparatuses.

Accordingly, the invention provides a system for supplying a gas including a gas-forming unit for forming a gas, a gas supply passage for supplying a gas produced from the gas-forming unit, a gas flow rate controller provided in the gas supply passage to control the flow rate of the gas flowing through the gas supply passage, a gas discharge passage provided in parallel with the gas supply passage to discharge the gas produced from the gas-forming unit, and a pressure controller provided in the gas discharge passage to control the pressure of the gas flowing through the gas discharge passage.

In the above system for supplying a gas, the pressure can be controlled in the gas supply passage on the side of the gas-forming unit, upon controlling the pressure of the gas that flows into the gas discharge passage. Therefore, it is possible to optimize the flow rate of the gas that is supplied and the amount of the gas generated by the gas-forming unit.

The invention also provides a system for supplying a gas, including a gas-forming unit for forming a gas, a gas supply passage for supplying a gas produced from the gas-forming unit, a gas flow rate controller provided in the gas supply passage to control the flow rate of the gas flowing through the gas supply passage, a buffer tank provided in the gas supply passage between the gas-forming unit and the gas flow rate controller, and a pressure adjuster provided in the gas supply passage between the gas-forming unit and the gas flow rate controller to adjust the pressure of the gas flowing through the gas supply passage.

In the above system for supplying a gas, even when the flow rate through the gas supply passage is controlled by the gas flow rate controller, the effect thereof can be eliminated by the buffer tank and the pressure adjuster decreasing the effect upon the pressure in the gas-forming unit. Therefore, it is possible to optimize the flow rate of the gas that is supplied and the amount of the gas generated by the gas-forming unit.

The gas supply passage may include a plurality of gas supply pipes arranged in parallel and gas flow rate controllers provided in these gas supply pipes to control the flow rates of the gas flowing through the gas supply pipes.

Further, the system for supplying a gas may include a plurality of treating apparatuses connected to this plurality of gas supply pipes.

### BRIEF DESCRIPTION OF THE DRAWINGS

FIG. 1 is a diagram schematically illustrating the constitution of a system for supplying a gas in a process of manufacturing semiconductor device according to an embodiment 1 of this invention;

FIG. 2 is a diagram schematically illustrating the constitution of a system for supplying a gas in a process of manufacturing semiconductor device according to an embodiment 2 of this invention;

FIG. 3 is a diagram schematically illustrating the constitution of a system for supplying a gas in a process of manufacturing semiconductor device according to an embodiment 3 of this invention;

FIG. 4 is a diagram schematically illustrating the constitution of a system for supplying a gas in a process of manufacturing semiconductor device according to an embodiment 4 of this invention;

FIG. 5 is a time chart illustrating a relationship between the operation of the pneumatic valve in the system for supplying a gas shown in FIG. 4 and the amount of an ozone gas supplied into a semiconductor-treating apparatus;

FIG. 6 is a diagram schematically illustrating the constitution of a system for supplying a gas in a process of manufacturing semiconductor device according to an embodiment 5 of this invention;

FIG. 7 is a diagram schematically illustrating the constitution of another system for supplying a gas in a process of manufacturing semiconductor device according to the embodiment 5 of this invention;

FIG. 8 is a diagram schematically illustrating the constitution of a further system for supplying a gas in a process of manufacturing semiconductor device according to the embodiment 5 of this invention;

FIG. 9 is a diagram schematically illustrating the constitution of a system for supplying a gas in a process of manufacturing semiconductor device according to an embodiment 6 of this invention;

FIG. 10 is a diagram schematically illustrating the constitution of another system for supplying a gas in a process of manufacturing semiconductor device according to the embodiment 6 of this invention;

FIG. 11 is a diagram schematically illustrating the constitution of a system for supplying a gas in a process of manufacturing semiconductor device according to an embodiment 7 of this invention;

FIG. 12 is a diagram schematically illustrating the constitution of another system for supplying a gas in a process of manufacturing semiconductor device according to the embodiment 7 of this invention;

FIG. 13 is a diagram schematically illustrating the constitution of a system for supplying a gas in a process of manufacturing semiconductor device according to an embodiment 8 of this invention;

FIG. 14 is a diagram schematically illustrating the constitution of another system for supplying a gas in a process of manufacturing semiconductor device according to the embodiment 8 of this invention;

FIG. 15 is a diagram schematically illustrating the constitution of a system for supplying a gas in a process of manufacturing semiconductor device according to an embodiment 9 of this invention;

FIG. 16 is a diagram schematically illustrating the constitution of a system for supplying a gas in a process of manufacturing semiconductor device according to an embodiment 10 of this invention; and

FIG. 17 is a diagram schematically illustrating the constitution of a conventional system for supplying a gas.

### DETAILED DESCRIPTION OF THE PREFERRED EMBODIMENTS

Embodiments of the invention will now be described with reference to the drawings. The following description deals with a system for supplying a gas in a process of manufacturing semiconductor device by supplying an ozone gas, a formed gas or a reaction gas to a treating apparatus to treat the semiconductor wafers, such as forming a film or effecting the etching by using a gas, and a method of supplying a gas.

Though the following embodiments deal with the process of manufacturing the semiconductor device, it should be noted that the gas supply system and the gas supply method of the invention are in no way limited to the process of manufacturing the semiconductor device but may be applied to other processes of manufacturing the semiconductor device such as washing the wafers or peeling the resist, or may be applied to those in various other applications.

### Embodiment 1

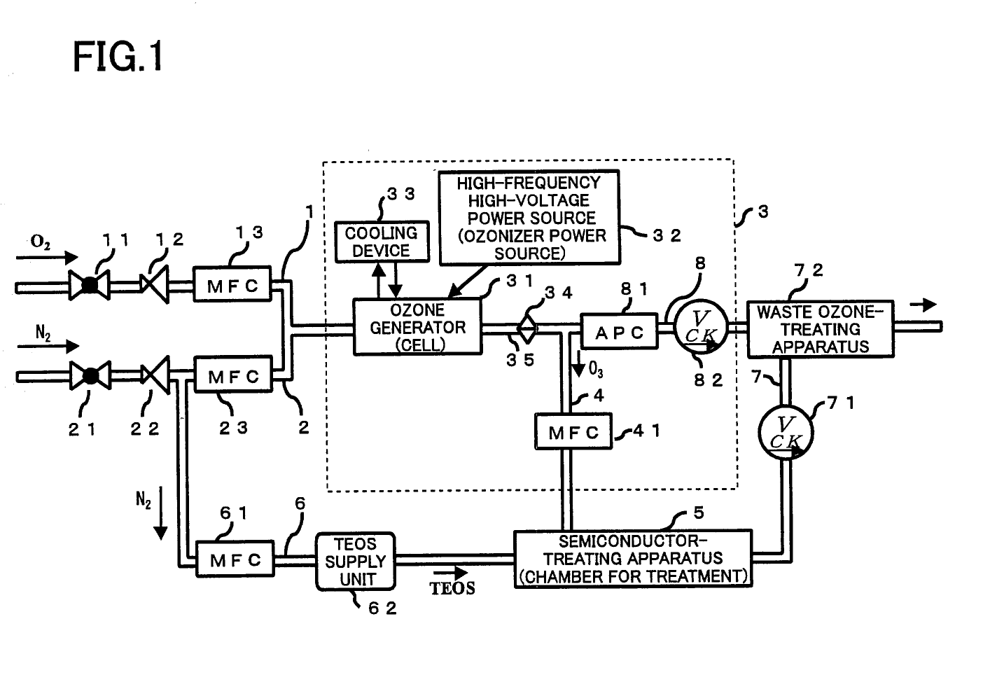

FIG. 1 is a diagram schematically illustrating the constitution of a system for supplying a gas in a process of manufacturing semiconductor device according to an embodiment 1.

As shown in the figure, the system for supplying a gas is chiefly constituted by a starting gas supply portion (conduits 1, 2, etc.) for supplying starting gases to a gas-forming unit, a gas-forming unit (ozone generator 31, etc.) for forming a gas from the starting gases, a gas supply passage (conduit 4) for supplying the gas produced from the gas-forming unit through a gas supply port, a semiconductor-treating apparatus 5 which is an apparatus for treatment, a TEOS gas supply portion (conduit 6, TEOS supply unit 62) for forming and supplying a TEOS gas, and a gas discharge portion (conduits 7, 8, etc.) inclusive of a gas discharge passage provided in parallel with the gas supply passage to discharge the gas produced from the gas-forming unit through a gas discharge port.

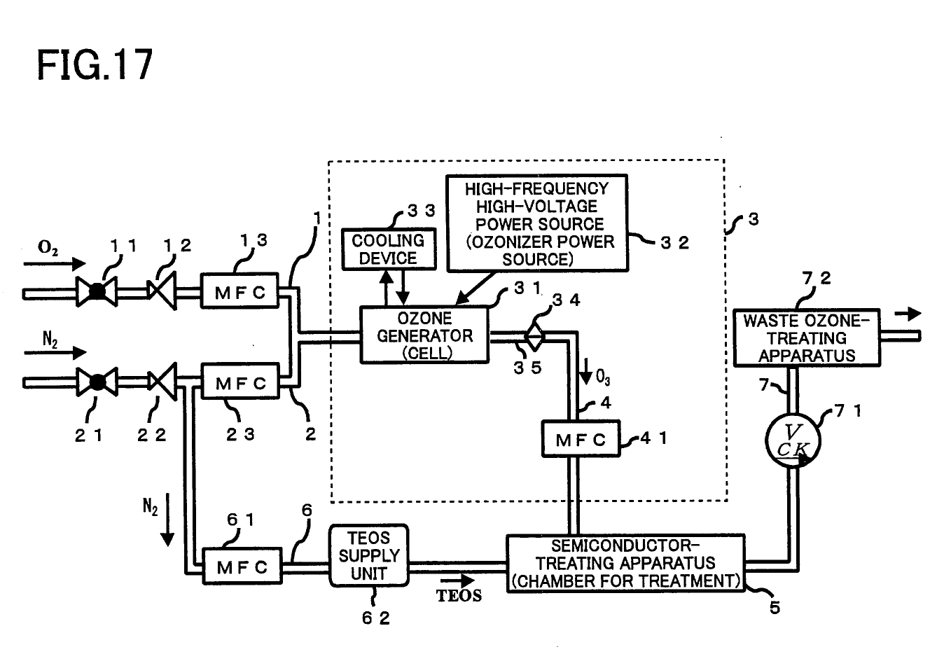

The starting gas supply portion is constituted by a conduit 1 that is connected at its one end to an ozone-generating apparatus 3 and supplies an oxygen gas which is a starting material to the ozone-generating apparatus 3, and a conduit 2 that is connected at its one end to the ozone-generating apparatus 3 and supplies a nitrogen gas which is another starting material to the ozone-generating apparatus 3. Like those shown in FIG. 17, the conduits 1 and 2 are provided with gas on/off valves 11, 21, gas pressure reducing valves 12, 22, and mass flow rate controllers (MFC) 13, 23 for controlling the flow rates of the gas, thereby to adjust the flow rates of the starting gases supplied through the conduits.

Like that of FIG. 17, the gas-forming unit is provided in an ozone-generating apparatus 3 and is constituted by an ozone generator (cell) 31 comprising electrodes facing each other, a high-frequency high-voltage power source (ozonizer power source) 32 for applying a high voltage to the electrodes of the ozone generator 31, a cooling device 33 for cooling the ozone generator 31, and a gas output pipe 35 provided with a gas filter 34.

In the ozone-generating apparatus 3, there is provided a conduit 4 (partly or wholly) as the gas supply passage that is connected at its one end to the gas output pipe 35 and supplies an ozone gas produced from the ozone generator 31 through a gas supply port. Like in FIG. 17, the gas supply passage (conduit 4) is provided with a mass flow rate controller (MFC) 41 which is a gas flow rate controller for controlling the flow rate of the gas flowing into the gas supply passage.

In the ozone-generating apparatus 3, there is further provided a gas discharge pipe 8 (partly or wholly) which is provided in parallel with the gas supply passage 4 and works as a gas discharge passage for discharging the gas produced from the gas-forming unit through a gas discharge port. The gas discharge passage (gas discharge pipe 8) is provided with a check valve 82 and an automatic pressure controller (APC) 81 which is a pressure controller for automatically controlling the pressure of the gas in the gas-forming unit 31 to assume a constant value by controlling the pressure of the gas flowing into the gas discharge pipe 8.

Namely, the APC 81 and the check valve 82 are connected in parallel with the MFC 41 which controls the flow rate of the ozone gas in the gas supply passage, to by-pass the ozone gas discharged from the APC 81 into a gas-decomposing apparatus (waste ozone-treating apparatus) 72.

Like in FIG. 17, the TEOS gas supply portion is constituted by a conduit 6 which is branched from the conduit 2 and is connected to the semiconductor-treating apparatus 5, a mass flow rate controller (MFC) 61 provided in the conduit 6, and a TEOS supply unit 62.

The semiconductor-treating apparatus 5 is an apparatus (chamber for treatment) for treating a semiconductor wafer by using the gas produced from the gas-forming unit 3 and the TEOS gas supplied from the TEOS gas supply unit 62.

As for the semiconductor treatment, there can be exemplified a treatment for forming a silicon oxide film on a semiconductor wafer by the chemical reaction of the ozone gas and the TEOS gas that are supplied. The semiconductor treatment, however, is in no way limited to the one for forming the film but may be any other treatment such as etching, wafer washing or peeling of resist by utilizing the gases that are supplied.

The gas discharge portion is constituted by a gas discharge passage (gas discharge pipe 8) provided in parallel with the gas supply passage 4 to discharge, through a gas discharge port, the gas produced from the gas-forming unit, and a conduit 7 for discharging the gas from the semiconductor-treating apparatus 5 to the gas-decomposing apparatus (waste ozone-treating apparatus) 72. The gas remaining in the semiconductor-treating apparatus 5 is discharged through a check valve 71 and the waste ozone-treating apparatus 72 provided in the conduit 7.

The operation will be described next.

The ozone-generating apparatus 3 is supplied with oxygen through the conduit 1 and with nitrogen through the conduit 2, and an ozone gas is formed by the ozone generator 31 in the ozone-generating apparatus 3 from the starting gases (oxygen and nitrogen) that are supplied.

The ozone gas is produced through the gas output pipe 35, is supplied to the semiconductor-treating apparatus 5 through the gas supply pipe 4 provided with the MFC 41, and is discharged into the waste ozone-treating apparatus 72 through the gas discharge pipe 8 provided with the APC 81.

The ozone gas to be supplied to the semiconductor-treating apparatus 5 is controlled for its flow rate by the MFC 41 so as to flow at a suitable flow rate. In this embodiment, the flow rate of the gas is controlled together with the TEOS gas supplied through the conduit 6 so as to suitably conduct the treatment for semiconductors such as forming an oxide film on the surfaces of the wafers by the treatment with ozone.

When the flow rate through the conduit 4 is controlled by the MFC 41, on the other hand, the pressure is affected in the conduit 4 on the side of the ozone generator 31. In this embodiment, however, the gas discharge pipe 8 is arranged in parallel with the conduit 4. Upon controlling the pressure in the gas discharge pipe 8 by the APC 81, therefore, it is allowed to control the pressure in the conduit 4 on the side of the ozone generator 31 to assume a proper value. Accordingly, even when the flow rate through the conduit 4 is controlled by the MFC 41, the effect thereof can be eliminated by controlling the APC 81 in the gas discharge pipe 8 decreasing the effect upon the pressure in the ozone generator 31.

That is, in the case of increasing the amount of the ozone gas supplied to the semiconductor-treating apparatus 5 relying on the control operation of the MFC 41, the APC 81 may be automatically controlled so as to be closed, so that the amount of the ozone gas discharged from the APC 81 decreases. Conversely, in the case of decreasing the amount of the ozone gas supplied to the semiconductor-treating apparatus 5 relying on the control operation of the MFC 41, the APC 81 may be automatically controlled so as to be opened, so that the amount of the ozone gas discharged from the APC 81 increases. Relying upon this control operation, the pressure can be maintained constant in the ozone generator 31.

The system for supplying a gas of the embodiment 1 includes the gas discharge passage which is provided in parallel with the gas supply passage that supplies the gas produced by the gas-forming unit to discharge the gas produced by the gas-forming unit, and a pressure controller which is provided in the gas discharge passage to control the pressure of the gas that flows into the gas discharge passage. Upon controlling the pressure of the gas that flows into the gas discharge passage, therefore, the pressure can be controlled in the gas supply passage on the side of the gas-forming unit. As a result, despite the pressure changes in the gas supply passage on the side of the gas-forming unit, the effect on the pressure is eliminated based on the operation of the pressure controller, and the flow rate of the gas supplied through the gas supply passage and the pressure in the gas-forming unit are suitably controlled.

Being controlled by the pressure controller, further, the pressure in the gas-forming unit is controlled to become constant irrespective of a change in the flow rate of the gas flowing through the gas supply passage. Therefore, the gas-forming unit stably generates the gas.

Though this embodiment has employed the mass flow rate controller for controlling the flow rate of the gas, the flow rate of the gas may be adjusted even by using a gas flow rate controller (FC). Further, though the embodiment has dealt with controlling the ozone gas output, the same effect is obtained even by employing the control system that produces other formed gas or reaction gas.

### Embodiment 2

In the system for supplying a gas of the embodiment 1, one treating apparatus is connected to one gas-forming unit. In a system for supplying a gas of this embodiment 2, however, a plurality of treating apparatuses are connected to one gas-forming unit.

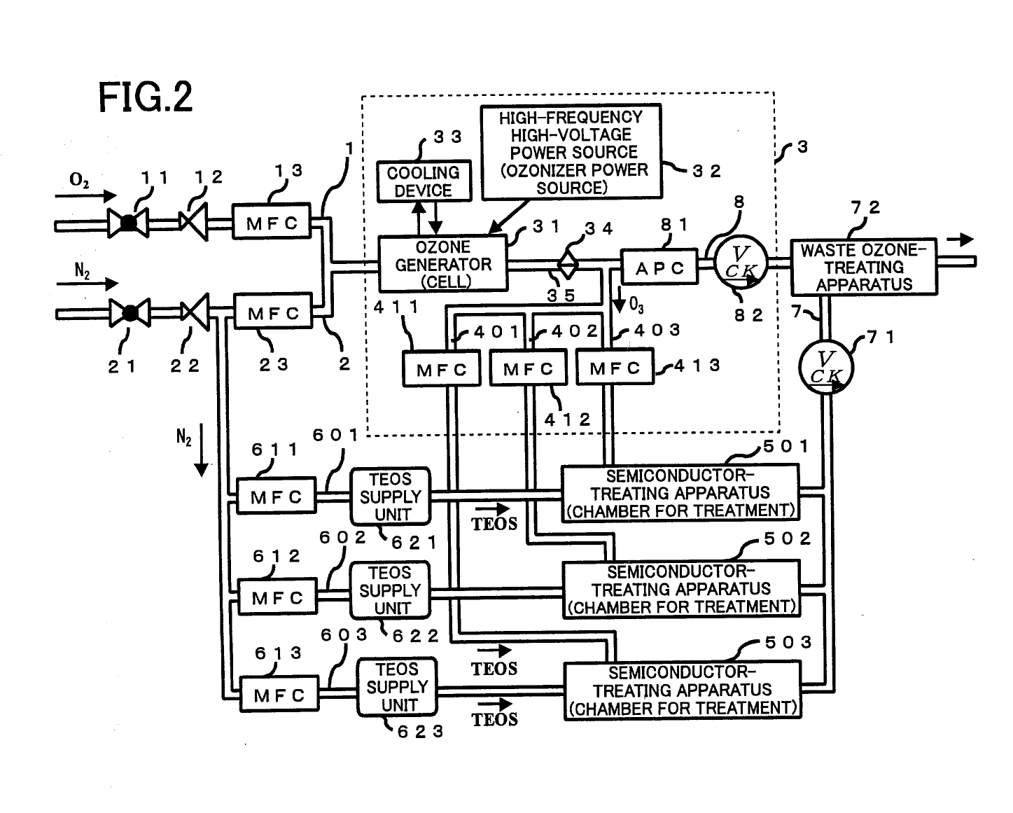

FIG. 2 is a diagram schematically illustrating the constitution of the system for supplying a gas in the process of manufacturing semiconductor device according to the embodiment 2. As shown in the figure, a plurality of semiconductor-treating apparatuses 501 to 503 are connected to the one gas-forming unit (ozone generator 31).

If described in detail, the semiconductor-treating apparatuses 501 to 503 are connected to the gas supply pipes 401 to 403 which are arranged in parallel and are connected to the gas output pipe 35 into which the gas formed by the ozone generator 31 is output. The ozone gas formed by the ozone generator 31 is supplied to the semiconductor-treating apparatuses 501 to 503 through the gas supply pipes 401 to 403. The gas supply pipes 401 to 403 are provided with mass flow rate controllers (MFC) 411 to 413, respectively, to control the flow rates of the gas through the gas supply pipes 401 to 403.

Besides, the conduit branched from the conduit 2 to supply the TEOS gas to the semiconductor-treating apparatus 5, is formed by a plurality of conduits 601 to 603 to be corresponded to the semiconductor-treating apparatuses 501 to 503, and the TEOS gas is supplied to the semiconductor-treating apparatuses 501 to 503 through the conduits 601 to 603. Further, the conduits 601 to 603 are provided with mass flow rate controllers (MFC) 611 to 613 and TEOS supply units 621 to 623.

In other regards, this embodiment is the same as the embodiment 1 inclusive of that the ozone gas produced by the ozone generator 31 is supplied to the semiconductor-treating apparatuses 501 to 503 through the gas supply passages 401 to 403, and that the gas discharge pipe 8 having the APC 81 as the gas discharge passage is provided in parallel with the gas supply passages 401 to 403 to discharge the gas produced by the gas-forming unit 31 through gas discharge ports.

Being constituted as described above, the flow rates of the ozone gas supplied to the semiconductor-treating apparatuses 501 to 503 are suitably controlled by the MFCs 411 to 413, and the flow rates of the TEOS gas that is supplied are suitably controlled by the MFCs 611 to 613.

Like in the case of the embodiment 1, the pressure in the conduits 401 to 403 is affected on the side of the ozone generator 31 by the operation of the MFCs 411 to 413. Upon controlling the pressure in the gas discharge pipe 8 communicated with the conduits 401 to 403 by operating the APC 81, however, the pressure in the conduits 401 to 403 can be suitably controlled on the side of the ozone generator 31. Even by controlling the flow rates through the conduits 401 to 403 by the MFCs 411 to 413, therefore, the effect is eliminated by the operation of the APC 81 in the gas discharge pipe 8, and the pressure in the ozone generator 31 is little affected.

In the embodiment 2, the pressure of the gas flowing into the gas discharge passage is controlled by the pressure controller to adjust the pressure in the gas supply passage on the side of the gas-forming unit. Therefore, the gas can be supplied from one gas-forming unit to the plurality of semiconductor-treating apparatuses at suitable flow rates, and the gas can be formed in a suitable amount by the gas-forming unit. It is therefore allowed to provide a cheap and compact system that stably supplies the gas to a plurality of semiconductor-treating apparatuses by simply employing one gas-forming unit having an increased gas-forming capacity.

### Embodiment 3

In a system for supplying a gas according to an embodiment 3, valves are provided for the gas supply pipes of the system for supplying a gas of the embodiment 2, and whether the gas be supplied to the treating apparatuses is independently controlled for each of the treating apparatuses.

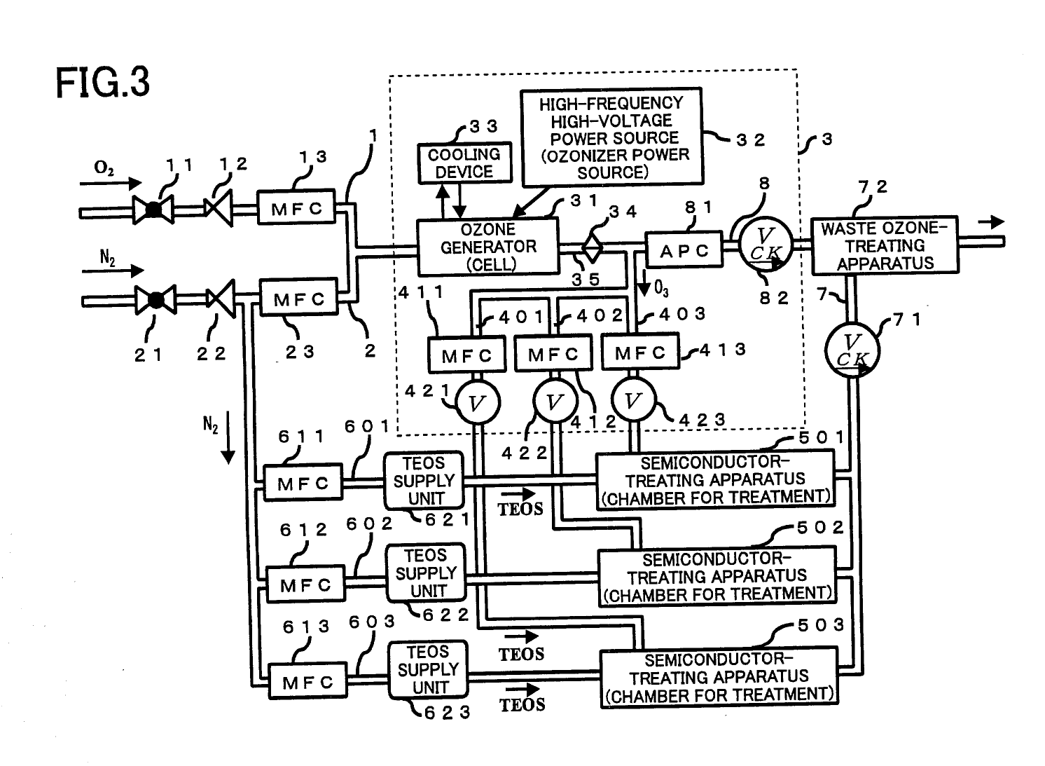

FIG. 3 is a diagram schematically illustrating the constitution of the system for supplying a gas in the process of manufacturing semiconductor device according to the embodiment 3. As shown in the figure, pneumatic pressure valves (inclusive of valves and open/close controllers for controlling the open/close of the valves) 421 to 423 are provided for the gas supply pipes 401 to 403 for supplying the gas to the semiconductor-treating apparatuses 501 to 503, in addition to those of the system for supplying a gas shown in FIG. 2. Though this embodiment uses the pneumatic pressure valves that are opened and closed by the pneumatic pressure, the valves are in no way limited thereto only but may be electromagnetic valves or valves that operate based on other methods.

By providing the gas supply pipes 401 to 403 with the pneumatic pressure valves 421 to 423 as described above, the gas formed by the same gas-forming unit 31 can be supplied to the plurality of semiconductor-treating apparatuses 501 to 503. For the semiconductor-treating apparatus that needs not be supplied with the gas, the supply of the gas is discontinued by simply closing the valve of the gas supply pipe leading to the semiconductor-treating apparatus. Namely, the gas is supplied to some semiconductor-treating apparatus while no gas is supplied to the other semiconductor-treating apparatus. Thus, the treatments are independently executed in the plurality of semiconductor-treating apparatuses by efficiently supplying the gas.

### Embodiment 4

In the systems for supplying a gas of the embodiments 1 to 3, the gas is supplied to one semiconductor-treating apparatus through one gas supply conduit. In a system for supplying a gas of an embodiment 4, the gas is supplied to one semiconductor-treating apparatus through a plurality of gas supply pipes, and the flow rates through the gas supply pipes and whether the gas be supplied through the gas supply pipes are controlled independently from each other.

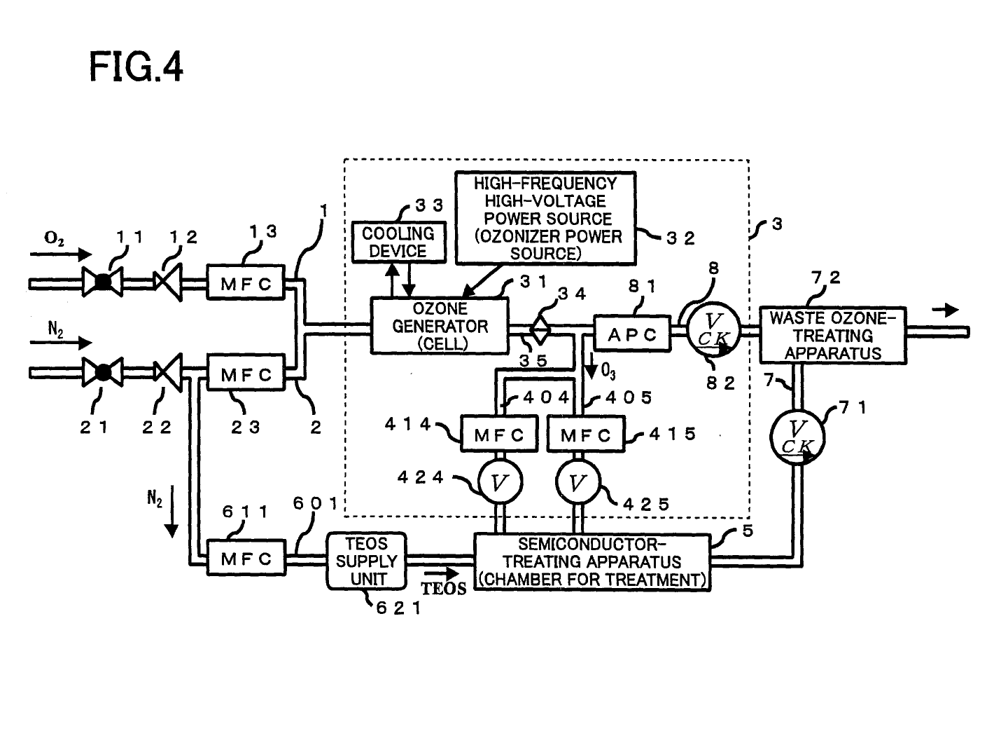

FIG. 4 is a diagram schematically illustrating the constitution of the system for supplying a gas in the process of manufacturing semiconductor device according to the embodiment 4. In the ozone-generating apparatus 3 as shown in the figure, there are provided a conduit 404 and a conduit 405 that are gas supply passages being connected to the gas output pipe 35 and arranged in parallel with each other to supply the gas into the semiconductor-treating apparatus 5 through gas supply ports thereof.

These conduits 404 and 405 are provided with mass flow rate controllers (MFC) 414, 415 for controlling the flow rates of the gas flowing through the gas supply passages and with pneumatic pressure valves 424 and 425 for controlling the open/close of valves relying on the pneumatic pressure. Though this embodiment uses the pneumatic pressure valves that are opened and closed by the pneumatic pressure, the valves are in no way limited thereto only but may be electromagnetic valves or valves that operate based on other methods.

In other regards, this embodiment is the same as the embodiment 1 inclusive of that the ozone gas produced by the ozone generator 31 is supplied to the semiconductor-treating apparatus 5 through the gas supply passages 404 and 405, and that the gas discharge pipe 8 having the APC 81 as the gas discharge passage is provided in parallel with the gas supply passages 404, 405 to discharge the gas produced by the gas-forming unit 31 through gas discharge port thereof.

Being constituted as described above, the flow rates through the gas supply pipes 404 and 405 are controlled independently of each other and the valves 424 and 425 are controlled, to instantaneously accomplish a suitable flow rate of the gas. That is, upon controlling the MFCs 414 and 415, the flow rates of the gas supplied through the conduits 404 and 405 are controlled independently of each other. Upon controlling the open/close of the pneumatic pressure valves 424 and 425, further it is controlled whether the gas can be supplied through the conduit 404 or through the conduit 405. Therefore, it is possible to supply the ozone gas to the semiconductor-treating apparatus 5 in a time-dividing manner.

Described below is a method of supplying the ozone gas to the semiconductor-treating apparatus 5 in a time-dividing manner.

The process of forming a silicon oxide film on the surface of the semiconductor wafer in the semiconductor-treating apparatus 5 can be roughly divided into three processes; i.e., a process (deposition process) of promoting the deposition of a silicon oxide film on the surface of the semiconductor wafer, a process (annealing process) of improving the quality such as insulation property of the silicon oxide film deposited on the surface of the semiconductor wafer, and a process (conveying process) of taking out the semiconductor wafer on which the film has been formed.

The treatments in these three processes require the gas in different amounts; i.e., the ozone gas is required in large amounts in the deposition process and in small amounts in the annealing process. Further, in the conveying process, the supply of the ozone must be discontinued and the carrier gas must be supplied, to replace the treated semiconductor wafer by the untreated semiconductor wafer. In order to enhance the production efficiency, it is necessary to improve the throughput for these tree processes, and the gas of a suitable amount must be supplied at any time into the semiconductor-treating apparatus 5.

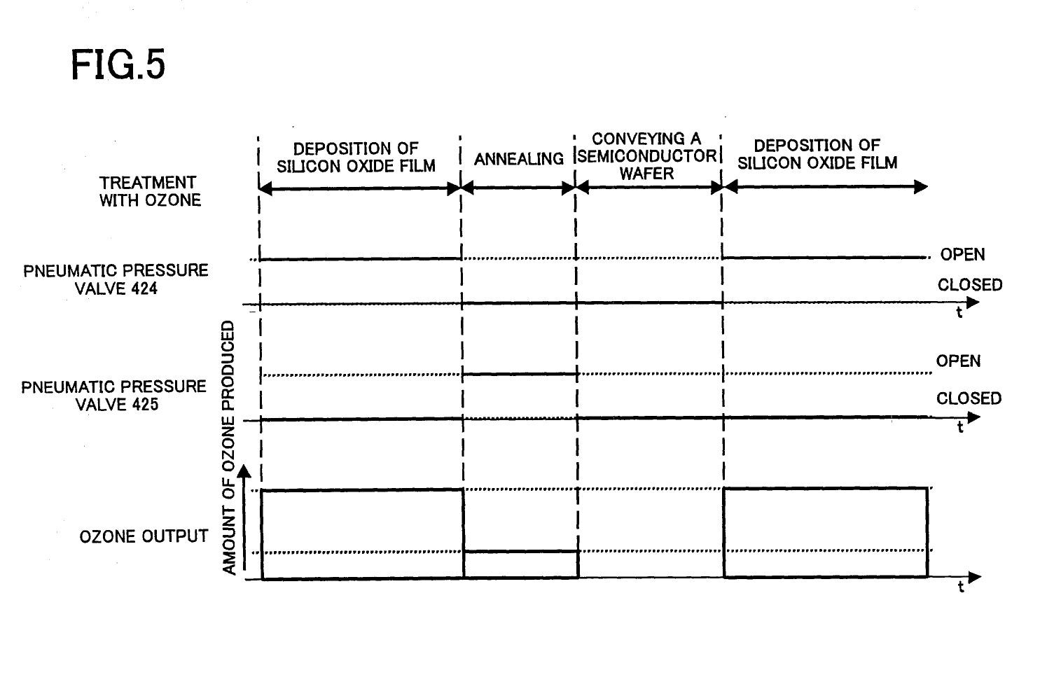

FIG. 5 is a time chart illustrating a relationship between the operation of the pneumatic valves and the amount of the ozone gas supplied to the semiconductor-treating apparatus when the semiconductor treatment inclusive of the above three processes is conducted in the gas supply system shown in FIG. 4. Here, the description does not refer to the relationships to chemicals or gas other than the ozone gas supplied to the semiconductor-treating apparatus.

The flow rate of the gas through the conduit 404 is set by the MFC 414 so that the ozone gas of an amount corresponding to the deposition process can be supplied from the conduit 404. On the other hand, the flow rate of the gas through the conduit 405 is set by the MFC 415 so that the ozone gas of an amount corresponding to the annealing process can be supplied from the conduit 405.

For example, when the ozone concentration produced from the ozone generator 31 is 150 g/Nm³, the flow rate through the conduit 404 is set to 5000 cc/min by the MFC 414, so that the ozone gas can be supplied in an amount as large as 12.5 mg/s to the semiconductor-treating apparatus 5, and the flow rate through the conduit 405 is set to 500 cc/min by the MFC 415, so that the ozone gas can be supplied to the semiconductor-treating apparatus 5 in an amount as small as 1.25 mg/s.

Thus, the open/close of the pneumatic valves 424 and 425 is controlled in a state where the two MFCs 414 and 415 have been set in advance; i.e., the ozone gas is supplied in a suitable amount from the conduit of which the valve is opened, and the above-mentioned three processes are smoothly conducted.

Namely, in the deposition process, the pneumatic pressure valve 424 is opened and the pneumatic valve 425 is closed, whereby the ozone gas is supplied from the conduit 404 into the semiconductor-treating apparatus 5 at a flow rate of 5000 cc/s which corresponds to the deposition process. In the annealing process, the pneumatic pressure valve 424 is closed and the pneumatic valve 425 is opened, whereby the ozone gas is supplied from the conduit 405 into the semiconductor-treating apparatus 5 at a flow rate of 500 cc/s which corresponds to the annealing process. In the conveying process, the pneumatic pressure valves 424 and 425 are both closed to discontinue the supply of ozone gas into the semiconductor-treating apparatus 5. While the supply has been discontinued, the gas is exchanged by supplying another carrier gas and the semiconductor wafer is exchanged.

In this embodiment 4, the gas is supplied to one semiconductor-treating apparatus through a plurality of gas supply pipes, the flow rates through these gas supply pipes are controlled independently of each other, and the gas is controlled to be supplied through any gas supply pipe. Therefore, the gas can be supplied at different flow rates into the one treating apparatus and, besides, the gas flow rate is instantaneously changed by controlling the open/close of the valves, contributing to improving the throughput of the semiconductor treatment.

Though this embodiment has dealt with the case of using only one semiconductor-treating apparatus like in the embodiment 1, it should be noted that the invention is in no way limited thereto only but can be adapted to the case of using a plurality of semiconductor-treating apparatuses like in the embodiments 2 and 3.

### Embodiment 5

In the system for supplying a gas of the embodiment 1, the pressure in the gas supply passage on the side of the gas-forming unit is controlled by controlling the pressure of the gas flowing through the gas discharge passage. In a system for supplying a gas of an embodiment 5, the pressure in the gas supply passage on the side of the gas-forming unit is controlled by providing the gas supply passage with the buffer tank and the pressure adjuster.

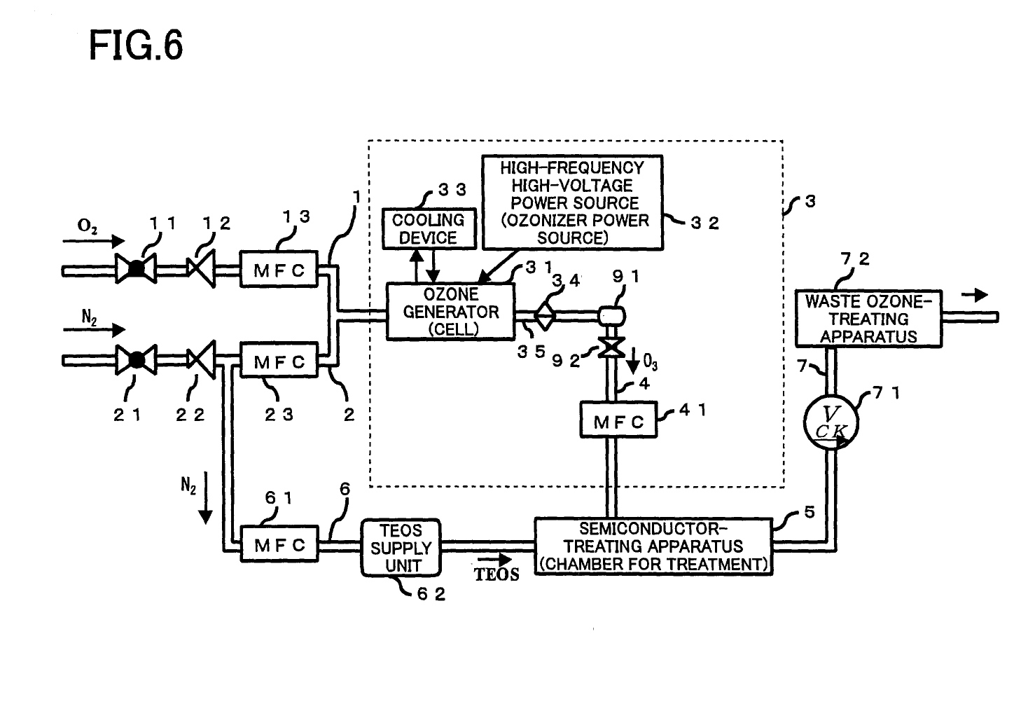

FIG. 6 is a diagram schematically illustrating the constitution of the system for supplying a gas in the process of manufacturing semiconductor device according to the embodiment 5.

As shown in the figure, the system for supplying a gas is chiefly constituted by a starting gas supply portion (conduits 1, 2, etc.) for supplying starting gases to a gas-forming unit, a gas-forming unit (ozone generator 31, etc.) for forming a gas from the starting gases, a gas supply passage (conduit 4) for supplying the gas produced from the gas-forming unit through a gas supply port thereof, a semiconductor-treating apparatus 5 which is an apparatus for treatment, a TEOS gas supply portion (conduit 6, TEOS supply unit 62) for forming and supplying a TEOS gas, and a gas discharge portion (conduit 7) for discharging the gas produced from the treating apparatus to the external side.

The starting gas supply portion, gas-forming unit, semiconductor-treating apparatus and TEOS gas supply portion are the same as those of Embodiment 1.

In the ozone-generating apparatus 3 like in FIG. 1, there is provided a conduit 4 (partly or wholly) as the gas supply passage that is connected at its one end to the gas output pipe 35 and supplies an ozone gas produced from the ozone generator 31 to the semiconductor-treating apparatus 5 through a gas supply port. The gas supply passage (conduit 4) is provided with a mass flow rate controller (MFC) 41 which is a gas flow rate controller for controlling the flow rate of the gas flowing into the gas supply passage.

In this embodiment 5, further, there are provided a buffer tank 91 capable of maintaining ozone in an amount sufficient to cope with a change in the flow rate caused by the MFC 41 and a pressure head nozzle 92 which is a pressure adjuster for adjusting the pressure in the gas supply passage on the side of the gas-forming unit between the gas-forming unit 31 and the gas flow rate controller (MFC) 41 in the gas supply passage.

The pressure adjuster is not limited to the pressure head nozzle only but may be any one which is capable of adjusting the pressure, such as a valve or a nozzle.

The operation will be described next.

Like in the embodiment 1, the ozone gas formed by the ozone generator 31 is produced from the gas output pipe 35 and is supplied to the semiconductor-treating apparatus 5 through the gas supply pipe 4 which is provided with the buffer tank 91, pressure head nozzle 92 and MFC 41. The ozone gas supplied to the semiconductor-treating apparatus 5 is suitably controlled for its flow rate by the MFC 41 like in the embodiment 1.

When the flow rate through the conduit 4 is controlled by the MFC 41, as described above, the pressure is affected in the conduit 4 on the side of the ozone generator 31. In this embodiment, however, the buffer tank 91 and the pressure head nozzle 92 are arranged between the gas-forming unit and the MFC 41 in the gas supply pipe 4, making it possible to maintain ozone in an amount sufficient for coping with a change in the flow rate caused by the MFC 41 relying upon the buffer tank 91 and to adjust the pressure in the gas supply passage on the side of the gas-forming unit relying upon the pressure head nozzle 92. It is therefore allowed to suitably control the pressure (to be, for example, constant) in the ozone generator 31. Therefore, even when the flow rate through the conduit 4 is controlled by the MFC 41, the effect thereof can be eliminated by the buffer tank 91 and the pressure head nozzle 92 decreasing the effect upon the pressure in the ozone generator 31.

The system for supplying in the embodiment 5 includes the buffer tank provided in the gas supply passage between the gas-forming unit and the gas flow rate controller, and includes the pressure adjuster provided in the gas supply passage between the gas-forming unit and the gas flow rate controller to adjust the pressure of the gas flowing through the gas supply passage. It is therefore made possible to control the pressure in the gas supply passage on the side of the gas-forming unit. As a result, despite the pressure changes in the gas supply passage on the side of the gas-forming unit, the effect on the pressure is eliminated, and the flow rate of the gas supplied through the gas supply passage and the pressure in the gas-forming unit are controlled to assume suitable values.

Being controlled by the pressure controller, further, the pressure in the gas-forming unit is controlled to become constant irrespective of a, change in the flow rate of the gas flowing through the gas supply passage. Therefore, the gas-forming unit stably generates the gas.

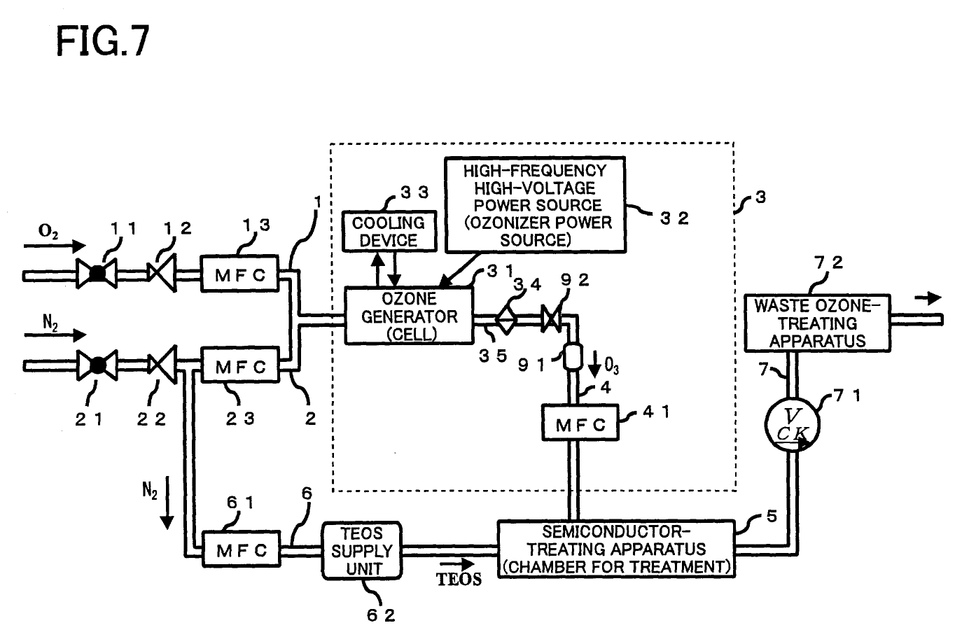

Here, the gas-forming unit 31, buffer tank 91, pressure adjuster 92 and MFC 41 are arranged in order mentioned. However, the buffer tank 91 and the pressure adjuster 92 may be arranged between the gas-forming unit 31 and the MFC 41. Therefore, the gas-forming unit 31, pressure adjuster (pressure head nozzle) 92, buffer tank 91 and MFC 41 may be arranged in this order as shown in FIG. 7.

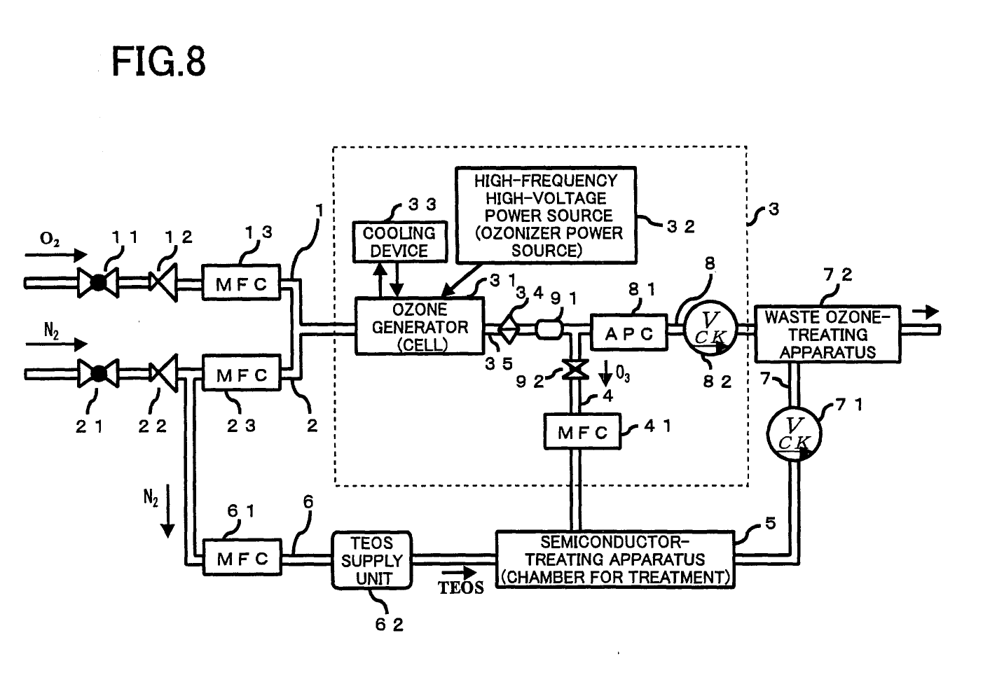

In the embodiment 5, further, the gas supply passage is provided with the buffer tank and the pressure adjuster to control the pressure in the gas supply passage on the side of the gas-forming unit. As shown in FIG. 8, however, the buffer tank and the pressure adjuster may be provided for the gas supply passage in the system for supplying a gas of the embodiment 1.

It is thus made possible to control the pressure of the gas flowing through the gas discharge passage and to control the pressure in the gas supply passage on the side of the gas-forming unit owing to the buffer tank and the pressure adjuster provided in the gas supply passage, in order to accomplish a more desired control operation.

### Embodiment 6

In the system for supplying a gas of the embodiment 5, one treating apparatus is connected to one gas-forming unit. In a system for supplying a gas of this embodiment 6, however, a plurality of treating apparatuses are connected to one gas-forming unit.

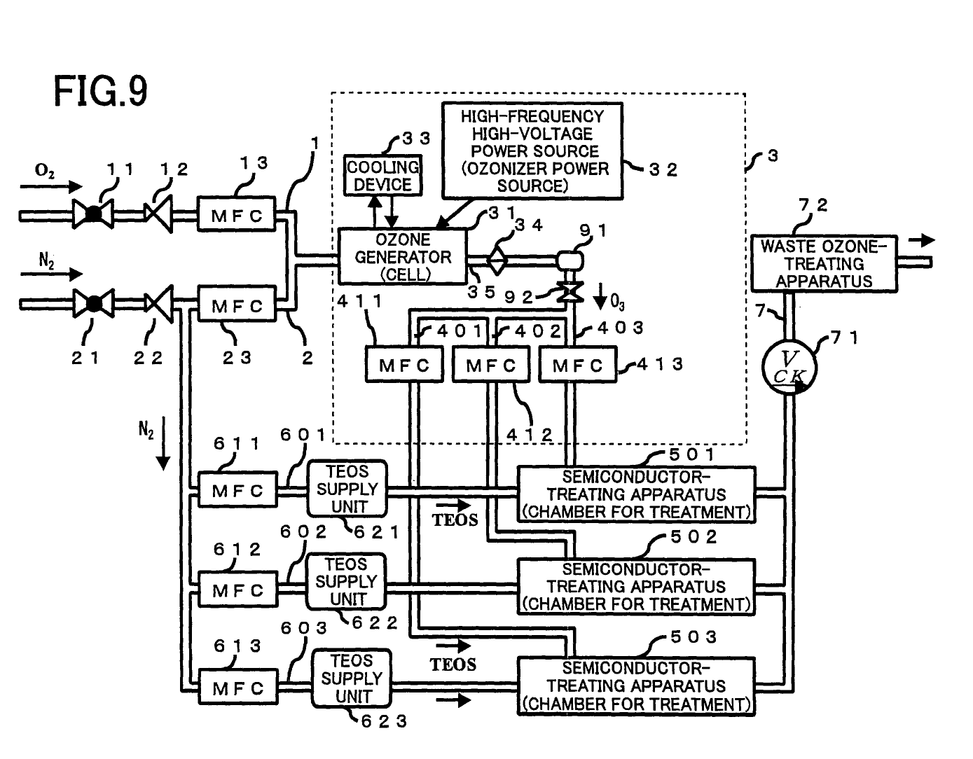

FIG. 9 is a diagram schematically illustrating the constitution of the system for supplying a gas in the process of manufacturing semiconductor device according to the embodiment 6. As shown in the figure, a plurality of semiconductor-treating apparatuses 501 to 503 are connected to the one gas-forming unit (ozone generator 31) like in FIG. 2 through the gas supply pipes 401 to 403 provided with MFCs 411 to 413.

The conduit branched from the conduit 2 to supply the TEOS gas to the semiconductor-treating apparatus 5, too, is divided into a plurality of conduits 601 to 603 being provided with MFCs 611 to 613 to be corresponded to the semiconductor-treating apparatuses 501 to 503.

In other regards, this embodiment is the same as the embodiment 5 inclusive of providing the buffer tank and the pressure adjusters such as the pressure head nozzle 92 in the gas supply passage between the gas-forming unit 31 and the gas flow rate controllers 411 to 413.

Like in the embodiment 5, therefore, the pressure in the gas supply passage can be adjusted on the side of the gas-forming unit relying upon the buffer tank 91 and the pressure adjuster 92, making it possible to suitably control the pressure in the ozone generator. Therefore, the gas can be supplied from one gas-forming unit to the plurality of semiconductor-treating apparatuses at suitable flow rates, and the gas is formed in a suitable amount by the gas-forming unit. It is therefore allowed to provide a cheap and compact system that stably supplies the gas to a plurality of semiconductor-treating apparatuses by simply employing one gas-forming unit having an increased gas-forming capacity.

In this embodiment as shown in FIG. 9, the buffer tank 91 and the pressure adjuster 92 are provided in the gas supply passage preceding a position where it is branched into three gas supply pipes 401 to 403. It is, however, also allowable to provide the buffer tank and the pressure adjuster for each of the three gas supply pipes 401 to 403.

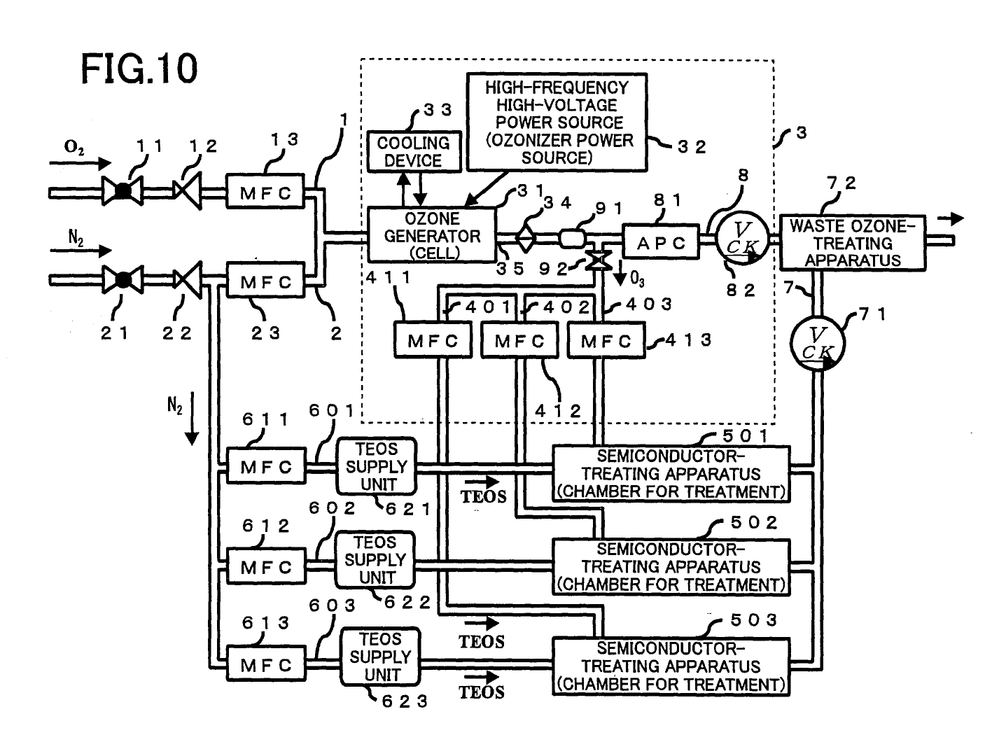

In the embodiment 6, further, the gas supply passage is provided with the buffer tank and the pressure adjuster to control the pressure in the gas supply passage on the side of the gas-forming unit. As shown in FIG. 10, however, the buffer tank and the pressure adjuster may be provided for the gas supply passage in the system for supplying a gas of the embodiment 2.

### Embodiment 7

In a system for supplying a gas according to an embodiment 7, valves are provided for the gas supply pipes of the system for supplying a gas of the embodiment 6, and whether the gas be supplied to the treating apparatuses is independently controlled for each of the treating apparatuses.

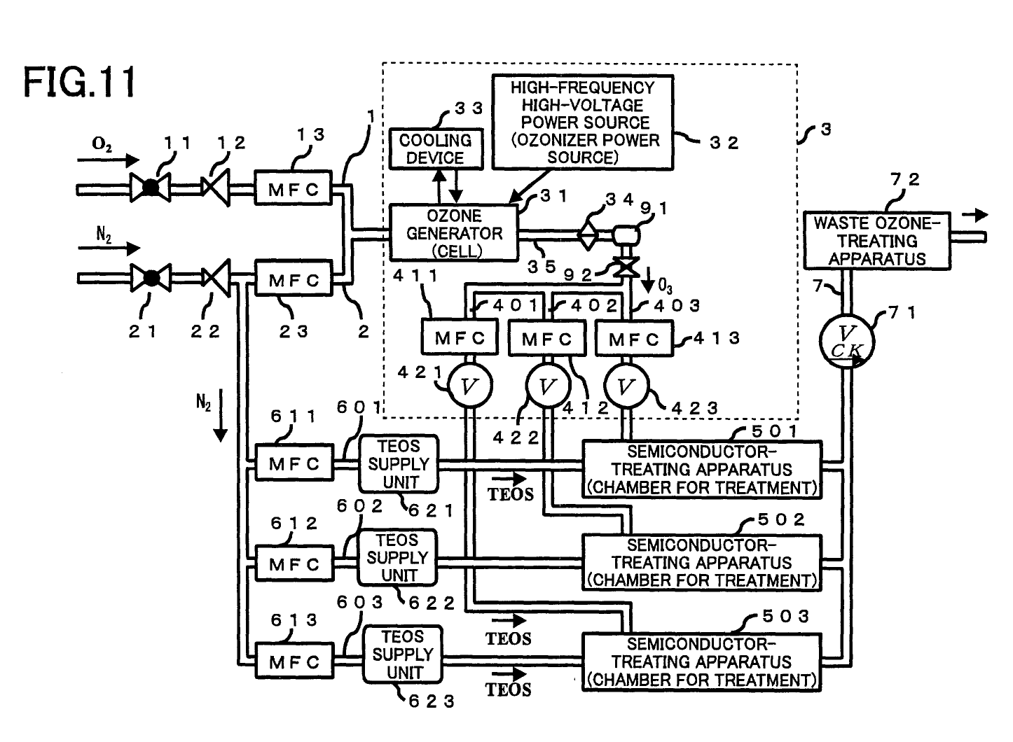

FIG. 11 is a diagram schematically illustrating the constitution of the system for supplying a gas in the process of manufacturing semiconductor device according to the embodiment 7. As shown in the figure, pneumatic pressure valves (inclusive of valves and open/close controllers for controlling the open/close of the valves) 421 to 423 are provided for the gas supply pipes 401 to 403 for supplying the gas to the semiconductor-treating apparatuses 501 to 503, in addition to those of the system for supplying a gas shown in FIG. 9. Though this embodiment uses the pneumatic pressure valves that are opened and closed by the pneumatic pressure, the valves are in no way limited thereto only but may be electromagnetic valves or valves that operate based on other methods.

By providing the gas supply pipes 401 to 403 with the pneumatic pressure valves 421 to 423 as described above, the gas formed by the same gas-forming unit 31 can be supplied to the plurality of semiconductor-treating apparatuses 501 to 503. For the semiconductor-treating apparatus that needs not be supplied with the gas, the supply of the gas is discontinued by simply closing the valves of the gas supply pipes leading to the semiconductor-treating apparatus. Namely, the gas is supplied to some semiconductor-treating apparatus while no gas is supplied to the other semiconductor-treating apparatus. Thus, the treatments are independently executed in the plurality of semiconductor-treating apparatuses, so that the gas efficiently supplied.

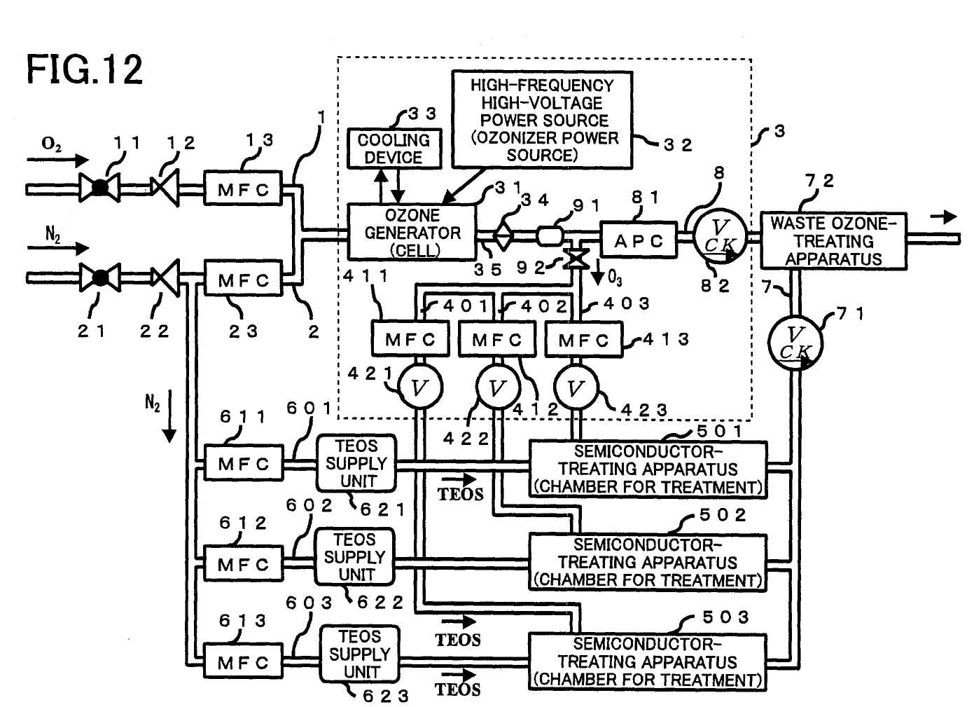

In the embodiment 7, further, the gas supply passage is provided with the buffer tank and the pressure adjuster to control the pressure in the gas supply passage on the side of the gas-forming unit. As shown in FIG. 12, however, the buffer tank and the pressure adjuster may be provided for the gas supply passage in the system for supplying a gas of the embodiment 3.

### Embodiment 8

In the systems for supplying a gas of the embodiments 5 to 7, the gas is supplied to one semiconductor-treating apparatus through one gas supply conduit. In a system for supplying a gas of an embodiment 8, the gas is supplied to one semiconductor-treating apparatus through a plurality of gas supply pipes, and the flow rates through the gas supply pipes and whether the gas be supplied through the gas supply pipes are controlled independently from each other.

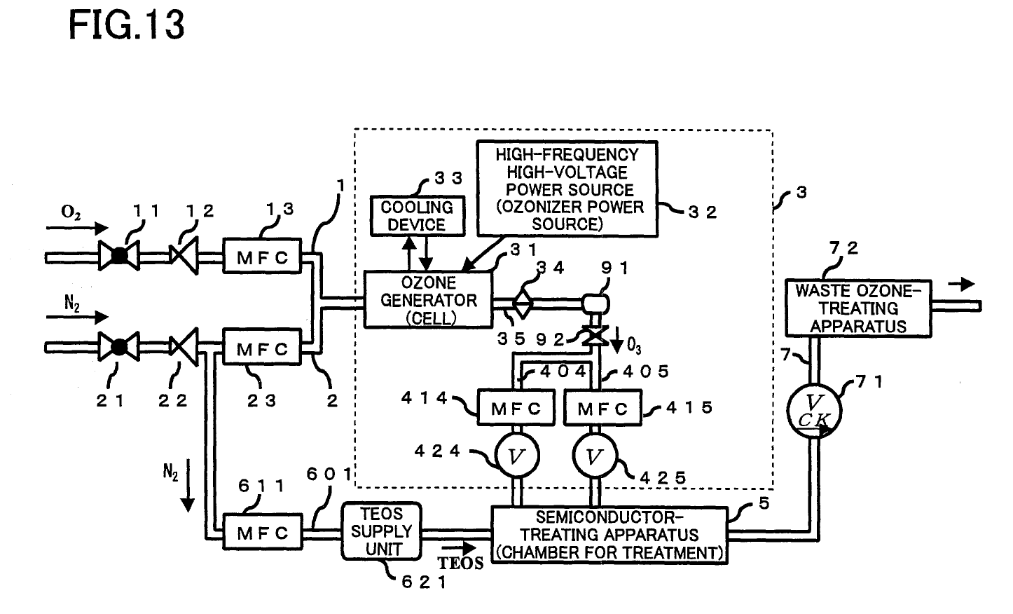

FIG. 13 is a diagram schematically illustrating the constitution of the system for supplying a gas in the process of manufacturing semiconductor device according to the embodiment 8. In the ozone-generating apparatus 3 as shown in the figure, there are provided a conduit 404 and a conduit 405 that are gas supply passage being connected to the gas output pipe 35 and arranged in parallel with each other to supply the gas into the semiconductor-treating apparatus 5 through gas supply ports thereof.

These conduits 404 and 405 are provided with mass flow rate controllers (MFC) 414, 415 as the gas flow rate controller for controlling the flow rates of the gas flowing through the gas supply passage and with pneumatic pressure valves 424 and 425 for controlling the open/close of the valves relying on the pneumatic pressure. Though this embodiment uses the pneumatic pressure valves that are opened and closed by the pneumatic pressure, the valves are in no way limited thereto only but may be electromagnetic valves or valves that operate based on other methods.

In other regards, this embodiment is the same as the embodiment 5 inclusive of that the buffer tank 91 and the pressure adjusters such as the pressure head nozzle 92 are provided in the gas supply passage between the gas-forming unit and the gas flow rate controller.

Being constituted as described above, the flow rates through the gas supply pipes 404 and 405 are controlled independently of each other and the valves 424 and 425 are controlled, to instantaneously accomplish a suitable flow rate of the gas. That is, upon controlling the MFCs 414 and 415, the flow rates of the gas supplied through the conduits 404 and 405 are controlled independently of each other. Upon controlling the open/close of the pneumatic pressure valves 424 and 425, further, it is controlled whether the gas can be supplied through the conduit 404 or through the conduit 405. Therefore, it is possible to supply the ozone gas to the semiconductor-treating apparatus 5 in a time-dividing manner as described in the embodiment 4.

In this embodiment 8, the gas is supplied to one semiconductor-treating apparatus through a plurality of gas supply pipes, the flow rates through these gas supply pipes are controlled independently of each other, and the gas is controlled to be supplied from any gas supply pipes. Therefore, the gas can be supplied at different flow rates into the one treating apparatus and, besides, the gas flow rates are instantaneously changed by controlling the open/close of the valves, contributing to improving the throughput of the semiconductor treatment.

Though this embodiment has dealt with the case of using only one semiconductor-treating apparatus like in the embodiment 5, it should be noted that the invention is in no way limited thereto only but can be adapted to the case of using a plurality of semiconductor-treating apparatuses like in the embodiments 6 and 7.

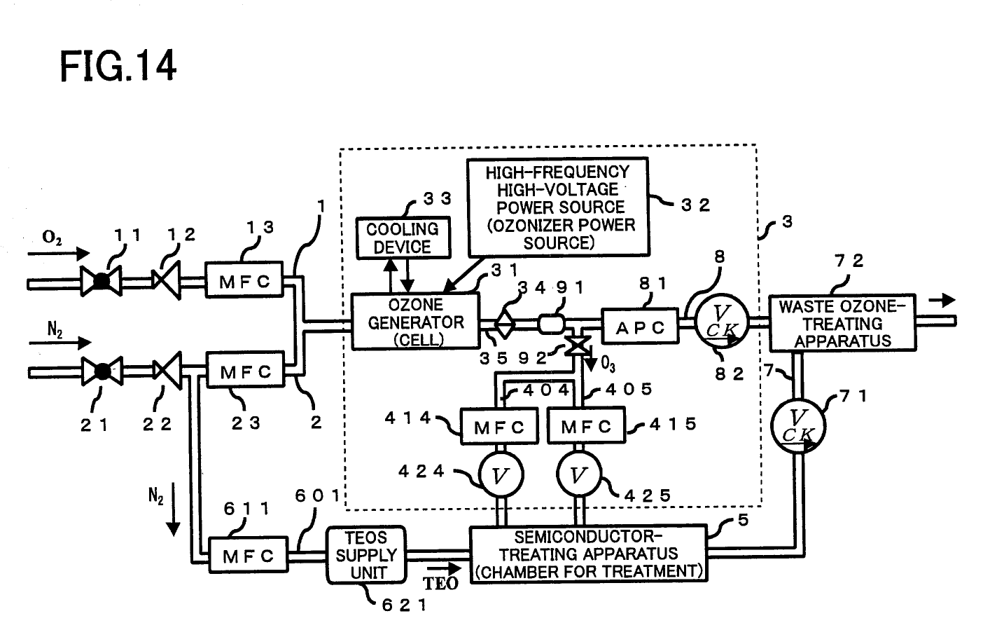

In the embodiment 8, further, the gas supply passage is provided with the buffer tank and the pressure adjuster to control the pressure in the gas supply passage on the side of the gas-forming unit. As shown in FIG. 14, however, the buffer tank and the pressure adjuster may be provided for the gas supply passage in the system for supplying a gas of the embodiment 4.

### Embodiment 9

In a system for supplying a gas according to an embodiment 9, an abnormal condition countermeasure function is provided for the systems for supplying a gas of the embodiments 1 to 8, in order to cope with the abnormal condition countermeasure function in case the pressure in the gas-forming unit becomes greater than a predetermined value.

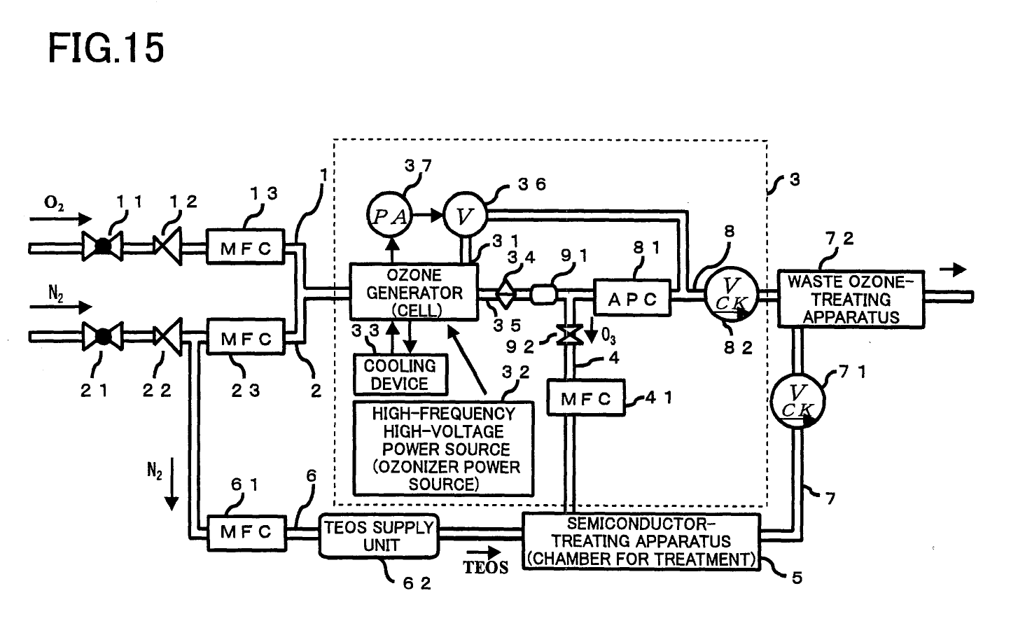

FIG. 15 is a diagram schematically illustrating the constitution of the system for supplying a gas in the process of manufacturing semiconductor device according to the embodiment 9, and in which the system for supplying a gas shown in FIG. 8 is provided with the abnormal condition countermeasure function. As shown in the figure, in the ozone generator (pressure container) 31 are provided a discharge pressure valve 36 and a pressure gauge 37 that produces a contact signal ON when the pressure in the ozone generator 31 exceeds a predetermined value. Here, though the system for supplying a gas shown in FIG. 8 is provided with the abnormal condition countermeasure function, the systems for supplying a gas of other embodiments, too, may be provided with the abnormal condition countermeasure function as a matter of course.

When the pressure gauge 37 indicates a pressure larger than a predetermined value, the pressure discharge valve 36 operates to suppress abnormal pressure and to output an abnormal pressure signal. And the ozonizer power source 32 is turned off in the ozone generator 31, or an instruction to suppress the amount of ozone generation is produced.

By providing a safety measure to cope with the pressure that may become abnormally high, it is allowed to automatically operate the system for supplying a gas in the process of manufacturing semiconductor device and to provide a system that is highly reliable.

### Embodiment 10

In a system for supplying a gas according to an embodiment 10, an abnormal condition countermeasure function is provided for the systems for supplying a gas of the embodiments 1 to 9, in order to cope with the abnormal condition countermeasure function in case the pressure in the gas-forming unit becomes smaller than a predetermined value.

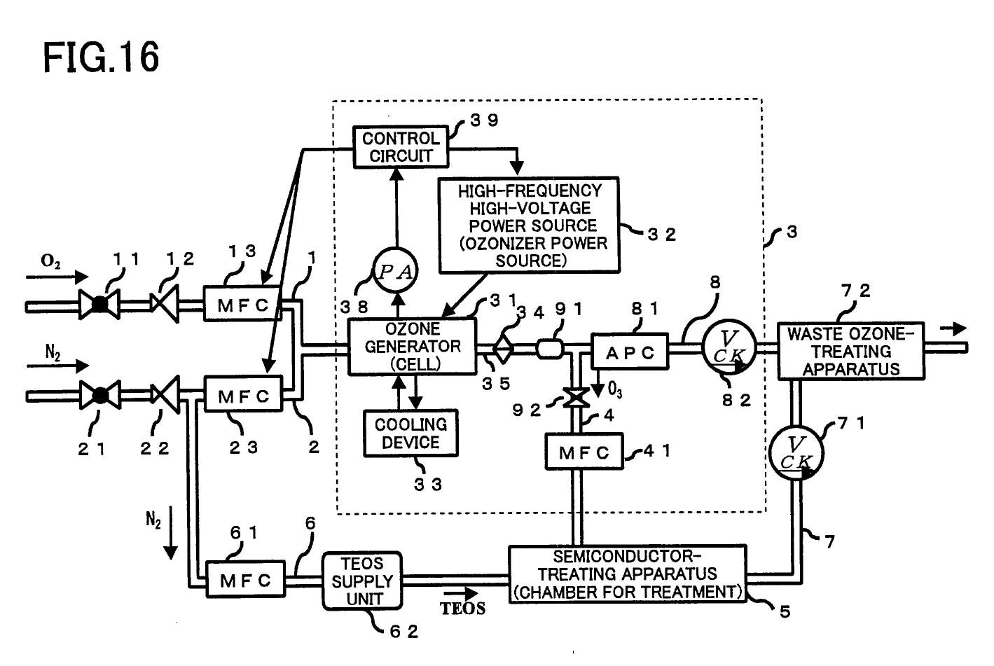

FIG. 16 is a diagram schematically illustrating the constitution of the system for supplying a gas in the process of manufacturing semiconductor device according to the embodiment 10, and in which the system for supplying a gas shown in FIG. 8 is provided with the abnormal condition countermeasure function. As shown in the figure, there are provided a pressure gauge 38 which detects the pressure in the ozone generator 31 and produces a pressure signal, and a control circuit 39 which, upon receipt of the pressure signal, sends an instruction for increasing or decreasing the generation of ozone to the ozonizer power source 32 and to the-mass flow rate controllers (MFCs) 13, 23 that control the flow rates of the starting gases. Here, though the system for supplying a gas shown in FIG. 8 is provided with the abnormal condition countermeasure function, the systems for supplying a gas of other embodiments may be provided with the abnormal condition countermeasure function as a matter of course.

The pressure gauge 38 detects the pressure in the ozone generator 31, and the normal control operation is conducted as in the embodiments 1 to 4 when the pressure lies within an operation range of the ozone generator 31. When the detected pressure lies outside the operation range (becomes abnormally low), the control circuit 39 produces an abnormally low pressure signal, whereby the ozonizer power source 32 is turned off, output of the ozonizer power source 32 is increased upon receiving an instruction for increasing the amount of ozone generation, or the flow rates of the starting gases are increased being controlled by the mass flow rate controllers (MFCs) 13, 23, thereby to increase the pressure in the ozone generator 31 by feed back. The feedback control may be executed relying upon a known method.

By providing a safety measure and a gas generation guarantee measure to cope with the pressure that may become abnormally low, it is allowed to automatically operate the system for supplying a gas in the process of manufacturing semiconductor device and to provide a system which is highly reliable. As a result of expanding the range of control operation, it is allowed to provide a system that is efficient and is highly reliable.

What is claimed is:

1. A system for supplying a gas, comprising:
a gas-forming unit for forming a gas;
a gas supply passage for supplying a gas produced from the gas-forming unit;
a gas flow rate controller provided in the gas supply passage to control the flow rate of the gas flowing through the gas supply passage;
a gas discharge passage provided in parallel with the gas supply passage to discharge the gas produced from the gas-forming unit; and
a pressure controller provided in the gas discharge passage to control the pressure of the gas flowing through the gas discharge passage.

2. The system for supplying a gas according to claim 1, wherein the pressure controller controls the pressure of the gas flowing through the gas discharge passage so that the pressure becomes constant in the gas-forming unit.

3. The system for supplying a gas according to claim 1, wherein a pressure gauge is provided to measure the pressure in the gas-forming unit, and an abnormal condition countermeasure is put into effect when the pressure measured by the pressure gauge lies outside a predetermined pressure range.

4. The system for supplying a gas according to claim 1, wherein the gas supply passage includes a plurality of gas supply pipes arranged in parallel and gas flow rate controllers provided in these gas supply pipes to control the flow rates of the gas flowing through the gas supply pipes.

5. The system for supplying a gas according to claim 4, wherein there are provided a plurality of treating apparatuses to which the plurality of gas supply pipes are connected, respectively.

6. The system for supplying a gas according to claim 4, wherein each gas supply pipe is provided with a valve and an open/close controller for controlling the open/close of the valve.

7. The system for supplying a gas according to claim 6, wherein there is provided a treating apparatus to which the plurality of gas supply pipes are connected.

8. The system for supplying a gas according to claim 7, wherein the plurality of gas supply pipes include a first gas supply pipe for supplying the gas at a first flow rate and a second gas supply pipe for supplying the gas at a second flow rate different from the first flow rate.

9. A system for supplying a gas, comprising:
a gas-forming unit for forming a gas;
a gas supply passage for supplying a gas produced from the gas-forming unit;
a gas flow rate controller provided in the gas supply passage to control the flow rate of the gas flowing through the gas supply passage;
a buffer tank provided in the gas supply passage between the gas-forming unit and the gas flow rate controller; and
a pressure adjuster provided in the gas supply passage between the gas-forming unit and the gas flow rate controller to adjust the pressure of the gas flowing through the gas supply passage.

10. The system for supplying a gas according to claim 9, wherein the pressure adjuster controls the pressure of the gas flowing through the gas supply passage so that the pressure becomes constant in the gas-forming unit.

11. The system for supplying a gas according to claim 9, wherein a pressure gauge is provided to measure the pressure in the gas-forming unit, and an abnormal condition countermeasure is put into effect when the pressure measured by the pressure gauge lies outside a predetermined pressure range.

12. The system for supplying a gas according to claim 9, wherein the gas supply passage includes a plurality of gas supply pipes arranged in parallel and gas flow rate controllers provided in these gas supply pipes to control the flow rates of the gas flowing through the gas supply pipes.

13. The system for supplying a gas according to claim 12, wherein there are provided a plurality of treating apparatuses to which the plurality of gas supply pipes are connected, respectively.

14. The system for supplying a gas according to claim 12, wherein each gas supply pipe is provided with a valve and an open/close controller for controlling the open/close of the valve.

15. The system for supplying a gas according to claim 14, wherein there is provided a treating apparatus to which the plurality of gas supply pipes are connected.

16. The system for supplying a gas according to claim 15, wherein the plurality of gas supply pipes include a first gas supply pipe for supplying the gas at a first flow rate and a second gas supply pipe for supplying the gas at a second flow rate different from the first flow rate.

17. A method of supplying a gas to control the flow rate of the gas supplied through a gas supply passage and to control the pressure in a gas-forming unit, by supplying a gas produced from the gas-forming unit through the gas supply passage, and by controlling the pressure of the gas flowing through the gas supply passage by using a buffer tank and a pressure adjuster disposed in the gas supply passage.

18. The method of supplying a gas according to claim 17, wherein the gas supply passage is constituted by a plurality of gas supply pipes arranged in parallel, and the gas is supplied in a manner of being controlled for their flow rates through these plurality of gas supply pipes.

19. The method of supplying a gas according to claim 17 to control the flow rate of the gas supplied through the gas supply passage and to control the pressure in the gas-forming unit, by discharging the gas through a gas discharge passage that is connected to the gas-forming unit, and by controlling the pressure of the gas flowing through the gas discharge passage.
